(19) United States
(12) Patent Application Publication
(10) Pub. No.: US 2022/0232878 A1
(43) Pub. Date: Jul. 28, 2022

(54) KETOGENIC CHOCOLATE-NUT SNACK AND METHOD OF MAKING

(71) Applicant: Elizabeth Yang, Monterey Park, CA (US)

(72) Inventor: Elizabeth Yang, Monterey Park, CA (US)

(21) Appl. No.: 17/161,377

(22) Filed: Jan. 28, 2021

(51) Int. Cl. A23L 33/00; A21D 2/18; A21D 13/062; A23L 33/20

(52) U.S. Cl. CPC A23L 33/30; A23L 33/20; A21D 13/062; A21D 2/181

(57) ABSTRACT

A ketogenic chocolate-nut snack and method of making. The ketogenic chocolate-nut snack provides a chocolate covered macadamia nut; with the keto chocolate, consisting of at least 70% cocoa solids. The keto chocolate is melted to form a gooey liquid form. A binding agent, such as a gluten or egg, is added to the melted keto chocolate, so as to enhance binding of the keto chocolate to the nut. The finished product can be chilled to solidify the bind of the keto chocolate on the macadamia nut. Flavoring agents and salt can be applied to further enhance the flavor. This produces a delicious high-fat, high-protein, low-carbohydrate snack that combines the benefits of a sugar substitute or no sugar content, a protein material, healthful minerals, and at least one flavoring.

### FIELD OF THE INVENTION

The present invention relates generally to a ketogenic chocolate-nut snack and method of making. More so, the present invention relates to a ketogenic chocolate-nut snack that coats a macadamia nut with melted keto chocolate, and further adds a binding agent—gluten or egg—to enhance binding of the chocolate to the nut, so as to produce a delicious high-fat, high-protein, low-carbohydrate snack that combines the benefits of a sugar substitute or no sugar content, a protein material, healthful minerals, and at least one flavoring.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, snack foods contain high amounts of refined sugar; have a high carbohydrate content: and are low in protein. Such snacks that are low in carbohydrates typically do not have a flavor that is favorable to a dieter's taste, and adding protein to such foods makes it harder to create and maintain a favorable flavor. This makes it difficult for the snacking person to use such snacks in a ketogenic diet, or even an Atkins diet. The result is that the person is less likely to follow the diet and obtain the benefits therefrom.

One popular snack, which is known in the art, is a nut covered with a topical coating. There are many nuggets, cookies, and clusters that utilize such nuts with a topical coating to improve the taste, appearance, nutrition, texture, stability or other feature of the product. Especially desirable, are coatings that are chocolate. However, the melting point of the cocoa butter constituent of chocolate is relatively low. A consequence of this low melting point temperature is that chocolate and chocolate coatings tend to soften or melt at relatively low temperatures leading to a poor bind with the surface of the nut. This also results in stability problems and clumping when the chocolate coating resets especially during transportation and storage.

Other proposals have involved methods and recipes for coating a nut with a topical topping, such as chocolate. The problem with these gripping devices is that they contain a high sugar and carbohydrate content. Also, the chocolate does not bind well with the surface of the nut. Even though the above cited involved methods and recipes for coating a nut with a topical topping meet some of the needs of the market, a ketogenic chocolate-nut snack and method of making that coats a macadamia nut with melted keto chocolate, and further adds a binding agent—gluten or egg—to enhance binding of the chocolate to the nut, so as to produce a delicious high-fat, high-protein, low-carbohydrate snack that combines the benefits of a sugar substitute or no sugar content, a protein material, healthful minerals, and at least one flavoring is still desired.

### SUMMARY

Illustrative embodiments of the disclosure are generally directed to a ketogenic chocolate-nut snack and method of making. The ketogenic chocolate-nut snack covers a macadamia nut with keto chocolate, consisting of at least 70% cocoa solids. The keto chocolate is melted to form a gooey liquid form. A binding agent, such as a gluten or egg, is added to the melted keto chocolate, so as to enhance binding of the keto chocolate to the nut. The keto chocolate mixture is then coated uniformly over the nut. The finished product can be chilled to solidify the bind of the keto chocolate on the macadamia nut. Flavoring agents and salt can be applied to further enhance the flavor. This produces a delicious high-fat, high-protein, low-carbohydrate snack that combines the benefits of a sugar substitute or no sugar content, a protein material, healthful minerals, and at least one flavoring.

In one aspect, a ketogenic chocolate-nut snack, comprises:
a keto chocolate having at least 70% cocoa solids, and at least one sugar substitute, the sugar substitute comprising between about 20% to about 50% of the keto chocolate by weight;
a binding agent mixed into the keto chocolate,
whereby the keto-chocolate and binding agent mixture are melted;
a nut,
whereby the melted keto-chocolate and binding agent mixture coat the nut,
whereby the covered nut is chilled to solidify the bind between the keto chocolate and the nut; and
a salt applied to the covered nut in amounts sufficient to provide a dry finished sprinkling.

In another aspect, the nut comprises a macadamia nut.

In another aspect, the binding agent comprises gluten.

In another aspect, the binding agent comprises an egg.

In another aspect, the keto chocolate has 75% cocoa solids.

In another aspect, the keto chocolate comprises a bitter dark chocolate.

In another aspect, the sugar substitute includes at least one of the following: Stevia, Sucralose, Erythritol, Xylitol, and Monk Fruit Sweetener, and Yacon Syrup.

In another aspect, the

In another aspect, the snack comprises at least one flavoring agent.

In another aspect, the flavoring agent comprises between about 5% to 30% of the keto chocolate by weight.

In another aspect, the flavoring agent includes at least one of the following: vanilla, ascorbic acid, citric acid, malic acid, tartaric acid, and fruit flavoring.

Additionally, a method of making the ketogenic chocolate-nut snack, comprises:
providing a keto chocolate having at least 70% cocoa solids, and at least one sugar substitute, the sugar substitute comprising between about 20% to about 50% of the keto chocolate by weight;
melting the keto chocolate;
mixing a binding agent into the melted keto chocolate, the mixture comprising:
   about 90% keto chocolate; and
   about 10% binding agent;
while the keto chocolate is still hot, covering a nut with the melted keto chocolate mixture;
applying a salt to the covered nut in amounts sufficient to provide a dry finished sprinkling; and
chilling the covered nut to solidify the bind between the keto chocolate and the nut.

In another aspect, the step of chilling the covered nut is at about 4 degrees Celsius or less.

One objective of the present invention is to provide a delicious high-fat, high-protein, low-carbohydrate snack that combines the benefits of a sugar substitute or no sugar content, a protein material, healthful minerals, and at least one flavoring.

Another objective is to provide a low or no sugar ketogenic friendly snack.

Yet another objective is to enhance the binding between the keto chocolate and the macadamia nut.

An exemplary objective is to provide an inexpensive to make ketogenic snack.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a Table of ingredients for an exemplary ketogenic chocolate-nut snack, in accordance with an embodiment of the present invention; and

FIG. 2 illustrates a flowchart of an exemplary method for making a ketogenic chocolate-nut snack, in accordance with an embodiment of the present invention.

Like reference numerals refer to like parts throughout the various views of the drawings.

### DETAILED DESCRIPTION OF THE INVENTION

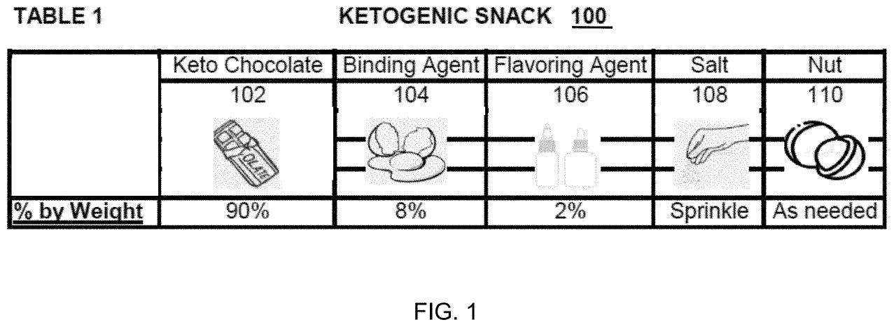

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

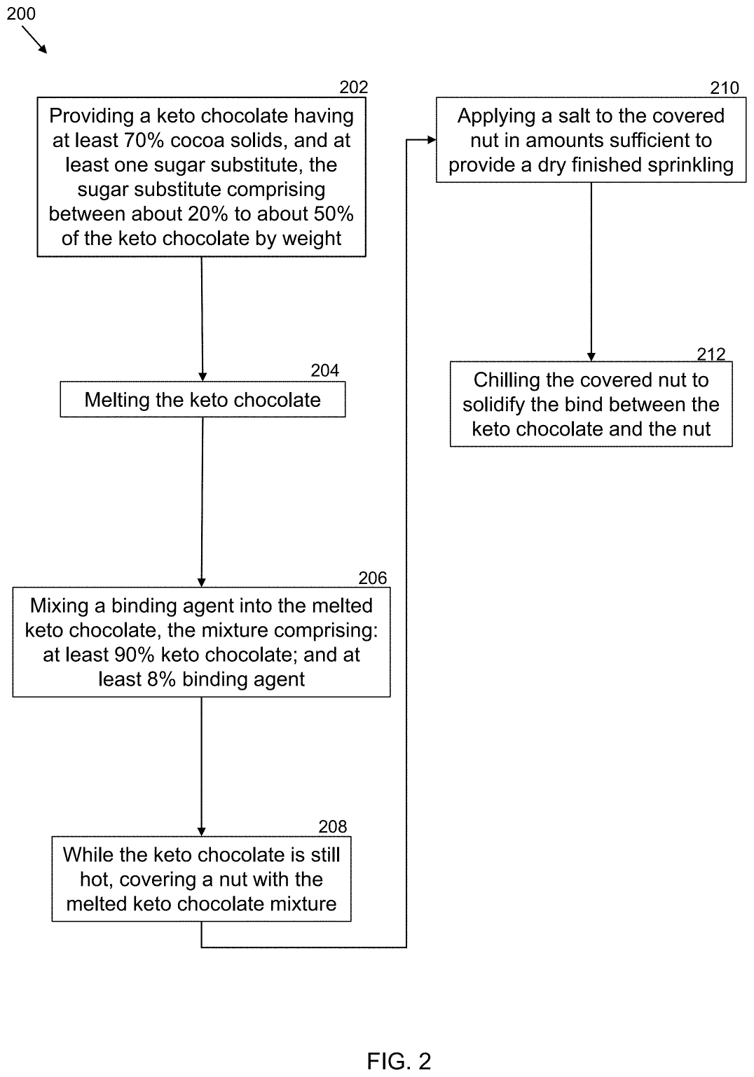

A ketogenic chocolate-nut snack 100 and method 200 of making is referenced in FIGS. 1-2. The ketogenic chocolate-nut snack 100, hereafter “snack 100”, is a unique chocolate covered nut “nugget” that provides a macadamia nut that is uniformly coated with a healthful, low or no sugar content keto chocolate 102. Quite uniquely, a binding agent 104 is added to the mixture, so as to enhance the binding between the keto chocolate and the outer surface of the nut 110. The binding agent 104 enables the nut 110 to be more uniformly coated with the keto chocolate 102. Additionally, at least one flavoring agent 106 and a salt 108 inay be introduced into the recipe to enhance the overall flavor of the snack 100.

Being ketogenic, the snack 100 provides numerous advantageous to sugar-loaded and carbohydrate-heavy snacks known in the art. Firstly, the snack 100 provides increased nutritional value with the addition of plant and animal-based proteins, i.e., binding agent 104 in the form of egg or glutton. Second, the snack 100 decreases the amount of carbohydrates compared to typical snack food by reducing or eliminating sugars, starches and grain-based flours and products. The snack 100 also reduces the amount of net effective carbohydrates by adding sugar alcohols or high intensity sweeteners and carbohydrate fibers. One exemplary embodiment of the snack 100 also contains added minerals and vitamins. Finally, the present snack 100 provides a flavorful combination of chocolate and macadamia nut that is very favorable to the taste.

Looking at FIG. 1, the ingredients for the snack 100 are organized in a table that shows the weight percentages for each ingredient. In one embodiment, the snack 100 comprises a keto chocolate 102 having at least 70% cocoa solids. In one non-limiting, the keto chocolate 102 has 75% cocoa solids. This cocoa content can include a bitter dark chocolate. However other variations of semi-sweet chocolate and white chocolate may also be used, as long as there is a ketogenic element thereto, i.e., sugar substitute.

The keto chocolate 102 consists of at least one sugar substitute. The use of a sugar substitute is one of the primary means through which the keto chocolate 102 reduces or eliminates sugar content and carbohydrates. This is efficacious for practicing a ketogenic diet. In some embodiments, the sugar substitute comprises between about 20% to about 50% of the keto chocolate 102 by weight. As Table 1 references, the sugar substitute is about 30% of the total weight of the keto chocolate 102 (See FIG. 1). However, lesser percentages may also be used. In some embodiments, the sugar substitute may include, without limitation: Stevia, Sucralose, Erythritol, Xylitol, and Monk Fruit Sweetener, and Yacon Syrup.

One of the primary novelties of the present invention is to create a greater bond between the keto chocolate 102 and the aforementioned nut 110. Thus, a binding agent 104 is mixed into the keto chocolate 102, while in the melted state. In this manner, the keto-chocolate and binding agent 104 mixture are melted. In some embodiments, the binding agent 104 may include an egg and/or gluten. The egg is useful for gluten free diets; while the gluten may be used for dairy free diets. However, any binding agent 104 known in the art of food consumption may also be used, as long as there is a protein element therein.

Those skilled in the art will recognize that a binding agent 104, such as a protein found in eggs and glutens, have an elastic quality typical of a protein. When the binding agent 104 is added to the heated and melted chocolate, a flexible chain that helps bind to the outer surface of the nut 110. As the keto chocolate 102 cools on the nut 110, the protein coagulates to bind the keto chocolate 102 the outer surface of the nut 110. Similarly, for the gluten, which is a plant-based protein, the binding effect is substantially the same. This creates a more integrated chocolate taste for the nut that improves the taste, appearance, nutrition, texture, stability or other feature of the snack 100.

In some embodiments, the snack 100 comprises at least one flavoring agent 106. Ideally the flavoring agent 106 is added while the chocolate is being melted so as to more thoroughly integrate into the flavor of the chocolate. As shown in Table 1, the flavoring agent 106 comprises between about 5% to 30% of the keto chocolate 102 by weight. In some embodiments, the flavoring agent 106 may include, without limitation: vanilla, ascorbic acid, citric acid, malic acid, tartaric acid, and fruit flavoring. However, other flavoring agent 106s known in the art of desserts and chocolate confectioners may also be used.

As discussed above, a primary ingredient is a nut 110. That is because the melted keto-chocolate and binding agent 104 mixture coat the nut 110. In one non-limiting embodiment, the nut 110 comprises a macadamia nut. However, in other embodiments, various types of nuts may be used including, without limitation: pecans, peanuts, almonds, cashews, and combinations thereof. In any case, after being coated with the keto chocolate 102, the combined snack 100 is chilled to solidify the bind between the keto chocolate 102 and the nut 110, i.e., coagulated binding agent 104.

An alternative embodiment, a salt 108 may be applied to the keto chocolate 102 covered nut 110 in amounts sufficient to provide a dry finished sprinkling. The salt 108 can be applied prior to chilling so that it sticks to the still gooey texture of the keto chocolate 102. In some embodiments, the salt 108 may include a rock salt, a sea salt, a mountain salt, and a pink salt.

FIG. 2 illustrates a flowchart diagram of an exemplary method 200 of making a ketogenic chocolate-nut 110 snack 100. The method 200 may include an initial Step 202 of providing a keto chocolate 102 having at least 70% cocoa solids, and at least one sugar substitute, the sugar substitute comprising between about 20% to about 50% of the keto chocolate 102 by weight. The method 200 may further comprise a Step 204 of melting the keto chocolate 102. The keto chocolate 102 can be melted over a low heat fire or stovetop, as is known in the art. The keto chocolate 102 should not be melted to the point of complete liquification.

A Step 206 includes mixing a binding agent 104 into the melted keto chocolate 102, the mixture comprising: about 90% keto chocolate 102; and about 10% binding agent 104. However, other percentage variances between the keto chocolate 102 and binding agent 104 are possible. The heat from the melted keto chocolate 102 stretches the binding agent 104 to enable optimal surface coverage of the nut 110, as described below. In some embodiments, a Step 208 comprises, while the keto chocolate 102 is still hot, covering a nut 110 with the melted keto chocolate 102 mixture. Multiple nut 110s can be placed on a sheet pan, and the chocolate purred over the nut 110s until fully covered.

A Step 210 may include applying a salt 108 to the covered nut 110 in amounts sufficient to provide a dry finished sprinkling. The sat can be sprinkled on while the texture of the keto chocolate 102 is still gooey, so as to catch the salt 108. In some embodiments, a final Step 212 comprises chilling the covered nut 110 to solidify the bind between the keto chocolate 102 and the nut 110. In one possible embodiment, the step of chilling the keto chocolate 102 covered nut 110 involves chilling to about 4 degrees Celsius or less.

In conclusion, a ketogenic chocolate-nut 110 snack 100 covers provides a chocolate covered macadamia nut with the keto chocolate 102, consisting of at least 70% cocoa solids. The keto chocolate 102 is melted to form a gooey liquid form. A binding agent 104, such as a gluten or egg, is added to the melted keto chocolate 102, so as to enhance binding of the keto chocolate 102 to the nut 110. The finished product can be chilled to solidify the bind of the keto chocolate 102 on the macadamia nut. Flavoring agent 106s and salt 108 can be applied to further enhance the flavor. This produces a delicious high-fat, high-protein, low-carbohydrate snack 100 that combines the benefits of a sugar substitute or no sugar content, a protein material, healthful minerals, and at least one flavoring.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method of making the ketogenic chocolate-nut snack, the method comprising:
providing a keto chocolate having at least 70% cocoa solids, and at least one sugar substitute, the sugar substitute comprising between about 20% to about 50% of the keto chocolate by weight;
melting the keto chocolate;
mixing a binding agent into the melted keto chocolate, the mixture comprising:
at least 90% keto chocolate; and
at least 8% binding agent;
while the keto chocolate is still hot, covering a nut with the melted keto chocolate mixture;
applying a salt to the covered nut in amounts sufficient to provide a dry finished sprinkling; and
chilling the covered nut to solidify the bind between the keto chocolate and the nut.

2. The method of claim 1, further comprising, chilling the covered nut is at about 4 degrees Celsius or less.

3. The method of claim 1, wherein the nut comprises a macadamia nut.

4. The method of claim 1, wherein the binding agent comprises a gluten.

5. The method of claim 1, wherein the binding agent comprises an egg

6. The method of claim 1, wherein the keto chocolate comprises 75% cocoa solids.

7. The method of claim 1, wherein the keto chocolate comprises a bitter dark chocolate.

8. The method of claim 1, wherein the sugar substitute includes at least one of the following: Stevia, Sucralose, Erythritol, Xylitol, and Monk Fruit Sweetener, and Yacon Syrup.

9. The method of claim 1, further comprising, mixing at least one flavoring agent into the melted keto chocolate.

10. The method of claim 9, wherein the flavoring agent comprises up to 2% of the total mixture by weight.

11. The method of claim 10, wherein the flavoring agent includes at least one of the following: vanilla, ascorbic acid, citric acid, malic acid, tartaric acid, and fruit flavoring.

12. A ketogenic chocolate-nut snack, the snack comprising:
a keto chocolate having at least 70% cocoa solids, and at least one sugar substitute, the sugar substitute comprising between about 20% to about 50% of the keto chocolate by weight;
a binding agent mixed into the keto chocolate,
whereby the keto-chocolate and binding agent mixture are melted;
a nut,
whereby the melted keto-chocolate and binding agent mixture coat the nut,
whereby the covered nut is chilled to solidify the bind between the keto chocolate and the nut; and
a salt applied to the covered nut in amounts sufficient to provide a dry finished sprinkling.

13. The snack of claim 12, wherein the nut comprises a macadamia nut.

14. The snack of claim 12, wherein the binding agent comprises a gluten or an egg.

15. The snack of claim 12, wherein the keto chocolate comprises 75% cocoa solids.

16. The snack of claim 12, wherein the sugar substitute includes at least one of the following: Stevia, Sucralose, Erythritol, Xylitol, and Monk Fruit Sweetener, and Yacon Syrup.

17. The snack of claim 12, further comprising at least one flavoring agent, the flavoring agent being mixed into the melted keto chocolate.

18. The snack of claim 17, wherein the flavoring agent comprises up to 2% of the total mixture by weight.

19. The snack of claim 18, wherein the flavoring agent includes at least one of the following: vanilla, ascorbic acid, citric acid, malic acid, tartaric acid, and fruit flavoring.

20. A ketogenic chocolate-nut snack, the snack consisting of:
a keto chocolate having 75% cocoa solids, and at least one sugar substitute, the sugar substitute comprising about 25% of the keto chocolate by weight, the sugar substitute including at least one of the following: Stevia, Sucralose, Erythritol, Xylitol, and Monk Fruit Sweetener, and Yacon Syrup;
a binding agent mixed into the keto chocolate,
whereby the keto-chocolate and binding agent mixture are melted;
a nut,
whereby the melted keto-chocolate and binding agent mixture coat the nut,
whereby the covered nut is chilled to solidify the bind between the keto chocolate and the nut;
at least one flavoring agent, the flavoring agent being mixed into the melted keto chocolate, the flavoring agent including at least one of the following: vanilla, ascorbic acid, citric acid, malic acid, tartaric acid, and fruit flavoring; and
a salt, the salt being applied to the covered nut in amounts sufficient to provide a dry finished sprinkling.
